(19) United States
(12) Patent Application Publication
(10) Pub. No.: US 2009/0100745 A1
(43) Pub. Date: Apr. 23, 2009

(54) Insect Control Apparatus

(76) Inventor: Michael S. Knight, New Port Richey, FL (US)

Correspondence Address: Jay M. Schloff;Intellipex PLLC, Suite 245, 30200 Telegraph Road, Bingham Farms, MI, 48025, US

(21) Appl. No.: 12/254,665

(22) Filed: Oct. 20, 2008

Related U.S. Application Data
(60) Provisional application No. 60/981,131, filed on Oct. 19, 2007.

(51) Int. Cl. A01M 3/02; A01M 3/00; A01M 3/04

(52) U.S. Cl. 43/135; 43/134; 43/136

(57) ABSTRACT

Disclosed is an insect control apparatus. The insect control apparatus comprises a gun member and a pair of opposable pad members. The gun member comprises an elongated barrel, a gripping handle, and a trigger mechanism. The elongated barrel is configured with a plunger mechanism capable of a movement in a lateral direction. The gripping handle is adapted to extend from the elongated barrel at an angle to an axis of the elongated barrel. The trigger mechanism extends from the gripping handle and is operably coupled to the plunger mechanism for triggering the movement of the plunger mechanism. The pair of opposable pad members is operably coupled to the gun member. Each opposable pad member comprises an arm extension capable of being actuated by the movement of the plunger mechanism in the lateral direction for pressing opposable pad members against each other and retracting opposable pad members from each other.

### CROSS REFERENCE TO RELATED APPLICATIONS

The present invention claims priority under 35 United States Code, Section 119 on the U.S. Provisional Patent Application No. 60/981,131 filed on Oct. 19, 2007, the disclosure of which is incorporated by reference.

### FIELD OF THE INVENTION

The present invention relates in general to control of insects, and more particularly, to an insect control apparatus for trapping and killing insects.

### BACKGROUND OF THE INVENTION

Insects, such as flies and mosquitoes, typically dwell in human surroundings. Some insects are attracted to edible food products meant for human consumption. Such insects settle on food products causing contamination of the food products due to deposition of disease producing germs onto the food products, rendering the food products unfit for human consumption. Moreover, insects such as mosquitoes are known to carry harmful disease producing bacteria, thereby posing serious threat to human health. Controlling the insects, i.e. the insect population, is therefore necessary from a health perspective.

Devices known in the art for the controlling, suppressing, and killing insects include manually-directed tools, such as flyswatters, as well as chemical dispensers, such as aerosol pesticides.

The chemical dispensers, such as the aerosol pesticides, employ toxic chemical substances for suppression and killing of insects. Such chemical substances are limited to the environments in which they are deployed. Further, toxicity of such chemical substances presents a particular health hazard to children as well as persons with compromised immune systems. Furthermore, a user of a chemical dispenser is usually advised not to direct or apply the substance in a confined area, but rather, the user is advised to dispense the chemical substance over a larger area. Widespread dispersal of such aerosol pesticides increases health risks and causes inconveniences to the user, at the same time decreasing the insect-control efficacy thereof.

Further, the manually-directed tools, such as the flyswatters demonstrate a variety of shortcomings. The flyswatters lack internal mechanism for directing or improving a user's accuracy in striking a targeted insect. The result is often such that a user misses the targeted insect in attempting to strike, and the targeted insect escapes.

Accordingly, there exists a need for an apparatus with improved accuracy in striking a targeted insect for controlling and killing insects in indoor or outdoor environments. Further, there exits a need for an apparatus that provides ease of use, clean operation, and effective control and termination of insects. Furthermore, there exists a need for an apparatus capable of suppressing and killing insects precluding damage to the environment or posing threat to human health.

### SUMMARY OF THE INVENTION

In view of the forgoing disadvantages inherent in the prior-art, the general purpose of the present invention is to provide an insect control apparatus that is configured to include all advantages of the prior art, and to overcome the drawbacks inherent in the prior art.

An object of the present invention is to provide an insect control apparatus with improved accuracy in striking a targeted insect for controlling and killing insects in indoor or outdoor environments.

Another object of the present invention is to provide an insect control apparatus that provides ease of use, clean operation, and effective control and termination of insects.

Yet another object of the present invention is to provide an insect control apparatus capable of suppressing and killing insects precluding damage to indoor or outdoor environments or posing threat to human health.

To achieve the above objects, in an aspect of the present invention, an insect control apparatus is provided. The insect control apparatus includes a gun member and a pair of opposable pad members. The gun member comprises an elongated barrel, a gripping handle, and a trigger mechanism. The elongated barrel is configured with a plunger mechanism. The plunger mechanism is capable of a movement in a lateral direction. Further, the gripping handle is adapted to extend from the elongated barrel at an angle to an axis of the elongated barrel. Furthermore, the trigger mechanism is adapted to extend from the gripping handle. The trigger mechanism is operably coupled to the plunger mechanism for triggering the movement of the plunger mechanism in the lateral direction. The pair of opposable pad members is operably coupled to the gun member. More particularly, each opposable pad member of the pair of the opposable pad members comprises an arm extension disposed on the elongated barrel and is capable of being actuated by the movement of the plunger mechanism in the lateral direction. Actuating arm extensions of the pair of opposable pad member is capable of pressing the pair of opposable pads against each other, and, retracting the pair of opposable pads from each other.

The pair of opposable pad members may be directed towards a targeted insect and the trigger mechanism may be used to trigger the plunger mechanism for actuating the arm extensions. The actuating of the arm extensions may press the pair of opposable pad members against each other for suppressing and killing the targeted insect. The pair of opposable pad members provides the insect control apparatus with improved accuracy in striking a targeted insect in indoor or outdoor environments. Further, the insect control apparatus provides ease of use, clean operation, and effective control and termination of insects. Furthermore, the insect control apparatus does not involve dispensing of toxic chemical substances and is capable of suppressing and killing insects precluding any damage to the environment or posing threat to human health

This together with the other aspects of the present invention, along with the various features of novelty that characterized the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 illustrates a perspective view of an insect control apparatus including a pair of opposable pad members in retracted position from each other, in accordance with an embodiment of the present invention;

FIG. 2 illustrates a perspective view of the insect control apparatus of FIG. 1 with the pair of opposable pad members pressed against each other, in accordance with an embodiment of the present invention; and

FIG. 3 illustrates a perspective view of an exemplary pair of opposable pad members, in accordance with an embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The term “first,” “second,” and the like, herein do not denote any order, elevation or importance, but rather are used to distinguish placement of one element over another. The terms “a” and “an” herein do not denote a limitation of quantity, but rather denote the presence of at least one of the referenced item. The term “insect” used herein includes mosquitoes, bugs, worms, and the like.

The present invention provides an insect control apparatus. The insect control apparatus is an accurate and effective tool for extermination of insects in indoor or outdoor environments. The insect control apparatus precludes the use of toxic chemicals and/or pesticides to exterminate the insects and includes a mechanism that provides a clean and safe means for trapping and killing of the insects.

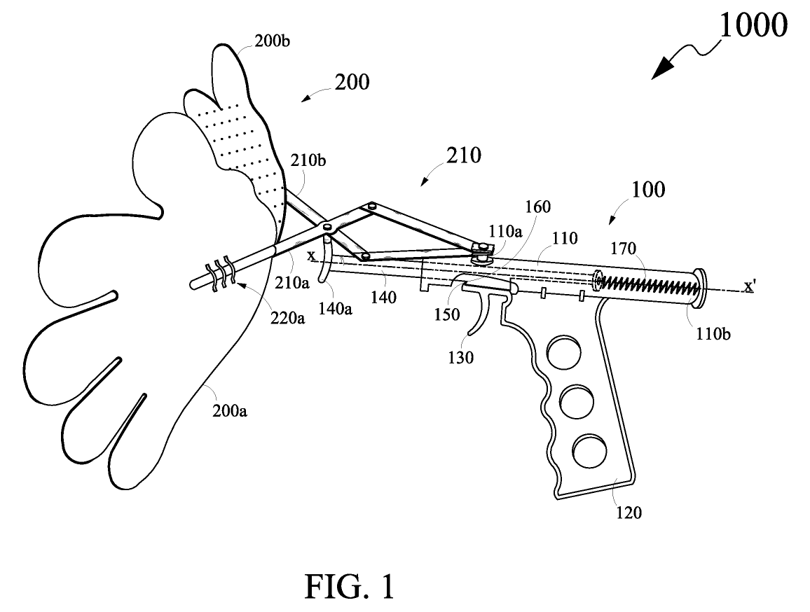

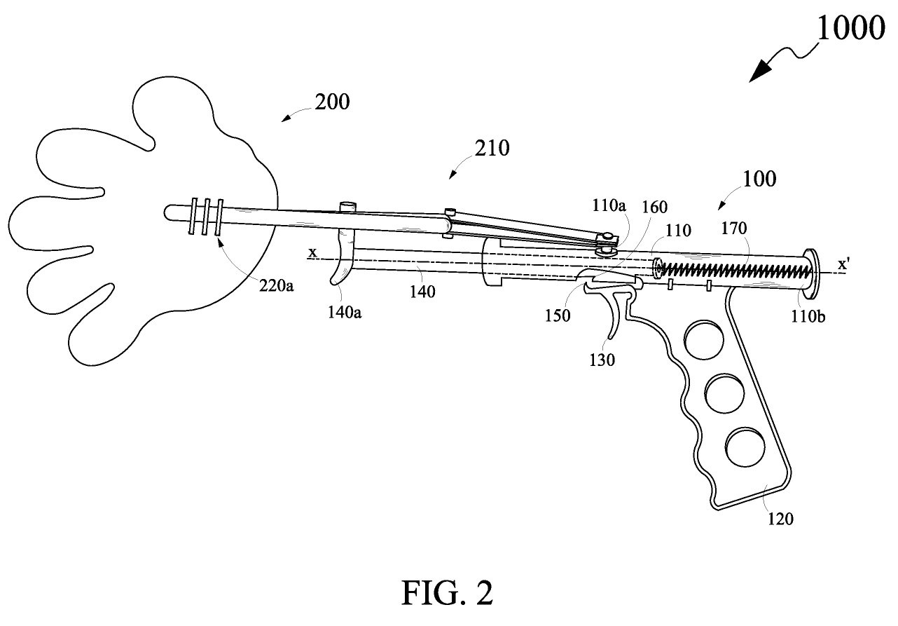

Referring now to FIGS. 1 and 2, perspective views of an insect control apparatus 1000 are illustrated, in accordance with an embodiment of the present invention. The insect control apparatus 1000 is hereinafter referred to as apparatus 1000. As shown in FIGS. 1 and 2, the apparatus 1000 includes a gun member 100 and a pair of opposable pad members 200, such as a first pad member 200a and a second pad member 200b, (hereinafter collectively referred to as ‘pad members 200’) operably attached thereto. FIG. 1 illustrates a perspective view of the apparatus 1000 with the pad members 200 in a retracted position from each other. The retracted position of the pad members 200 is referred to as ‘open’ position of the pad members 200. FIG. 2 illustrates a perspective view of the apparatus 1000 with the pad members 200 pressed against each other. The pressing of the pad members 200 against each other is referred as ‘close’ position of the pad members 200. The pad members 200 assume the open position and the close position to trap and kill insects.

The gun member 100 includes an elongated barrel 110, a gripping handle 120, a trigger mechanism 130 (hereinafter referred to as ‘trigger 130’), and a plunger mechanism 140 (hereinafter referred to as ‘plunger 140’). The elongated barrel 110 is configured with the plunger 140 in a manner such that the plunger 140 is capable of a movement in a lateral direction therewithin. More particularly, the plunger 140 is disposed within the elongated barrel 110 for the movement thereof in the lateral direction within the elongated barrel 110. A portion of the plunger 140 is configured to extend outwardly from the elongated barrel 110. The outwardly extending portion terminates in a vertical supporting element 140a. The movement of the plunger 140 in the lateral direction displaces the vertical supporting element 140a to assume a plurality of positions along the lateral direction. Further, the elongated barrel 110 includes a hinge mechanism 110a extending vertically upward therefrom. The hinge mechanism 110a and the vertical supporting element 140a will be discussed in detail subsequently in conjunction with the pad members 200.

The gripping handle 120 is adapted to extend from the elongated barrel 110 at an angle to an axis X-X′ of the elongated barrel 110. In one embodiment of the present invention, the angle subtended by the gripping handle 120 to the axis X-X′ lie in-between 0 degrees and 180 degrees. The trigger 130 is adapted to extend from the gripping handle 120 and is operable by a user's finger upon gripping the gun member 100 from the gripping handle 120. The trigger 130 is operably coupled to the plunger 140 for triggering the movement of the plunger 140 in the lateral direction within the elongated barrel 110. More particularly, the trigger 130 and the plunger 140 include a notch 150 and an indentation 160, respectively. The notch 150 is capable of being inserted into the indentation 160 for holding the plunger 140 at a position within the elongated barrel 110. Furthermore, for configuring operative coupling between the trigger 130 and the plunger 140, a resilient means, such as a spring 170 is provided. The spring 170 is configured within the elongated barrel 110 for facilitating the lateral movement of the plunger 140 within the elongated barrel 110. More particularly, the spring 170 is disposed within the elongated barrel 110 between an end portion 110b thereof and the plunger 140.

The pad members 200 are operably coupled to the gun member 100. Each of the pad members 200 is configured to define an outline of a human hand. The outline of the human hand may be dimensioned suitably to ensure suitable surface area for trapping and killing of insects. It will be evident to those skilled in the art that the each of the pad members 200 defining an outline of the human hand is depicted for exemplary purposes, and that the pad members 200 may be configured in a variety of shapes and sizes for ensuring effective trapping and killing of insects.

Each of the pad members 200, i.e. the first pad member 200a and the second pad member 200b, includes an arm extension. More specifically, the first pad member 200a includes an arm extension 210a, and, the second pad member 200b includes an arm extension 210b. The arm extension 210a and the arm extension 210b are hereinafter collectively referred to as arm extensions 210.

The arm extensions 210 are disposed on the elongated barrel 110 and extend horizontally outward from the hinge mechanism 110a to outer surfaces of the respective pad members 200, thereby operably coupling the pad members 200 to the gun member 100. The hinge mechanism 110a serves to affix the arm extensions 210 to the elongated barrel 110. In FIG. 1, the arm extensions 210 are depicted to be configured in a scissor arm configuration and are further hinge-supported at the cross-over junction by means of the vertical supporting element 140a. The vertical supporting element 140a thereby couples the arm extensions 210 to the plunger 140. The coupling of the plunger 140 to the arm extensions 210 actuates movement of the arm extensions 210 on the movement of the plunger 140 in the lateral direction. More specifically, a movement of the plunger 140 in an outwardly direction from the elongated barrel 110 extends the arm extensions 210, thereby, substantially aligning the arm extensions 210 with each other (as shown in FIG. 2). A movement of the plunger 140 inwardly into the elongated barrel 110 causes portions of the arm extensions 210 in-between the hinge mechanism 110a and the vertical supporting element 140a to move outwardly from each other, thereby retracting the arm extensions 210.

It will be apparent to a person skilled in the art that the scissor arm configuration of the arm extensions 210 supported at the vertical supporting element 140a and the hinge mechanism 110a is depicted for description purpose only, and, that the arm extensions 210 may not be limited in scope to the configuration as described herein. Moreover, one or more modifications to the arm extensions 210 may be contemplated for operably coupling the pad members 200 to the gun member 100.

The arm extension 210a and the arm extension 210b are attached to outer surfaces of the first pad member 200a and the second pad member 200b respectively by a means of series of strips, such as a series of strips 220a. As shown in FIGS. 1 and 2, the series of strips 220a attaches the arm extension 210a to an outer surface of the first pad member 200a. Similar to the series of strips 220a, a series of strips (not shown) attaches the arm extension 210b to an outer surface of the second pad member 200b. Though FIGS. 1 and 2, depict the attachment of arm extensions 210 to outer surfaces of the first pad member 200a and the second pad member 200b by means of the series of strips, it will be evident to those skilled in the art the arm extensions may be attached to the first pad member 200a and the second pad member 200b by other means, such as stitching, gluing, Velcro arrangement, and the like.

As described above, a movement of the plunger 140 in an outwardly direction from the elongated barrel 110 actuates the arm extensions 210 to extend in the lateral direction. The extension of the arm extensions 210 causes the pressing of the pad members 200 against each other, thereby, configuring the close position of the pad members 200 (depicted in FIG. 2). The movement of the plunger 140 inwardly into the elongated barrel 110 causes the portions of the arm extensions 210 in-between the hinge mechanism 110a and the vertical supporting element 140a to move outwardly from each other, thereby retracting the arm extensions 210. The retraction of the arm extensions 210 causes the pad members 200 to retract from each other, thereby configuring the open position of the pad members 200 (depicted in FIG. 1).

FIG. 1 depicts a pre-strike position of the apparatus 1000. At the pre-strike position, the notch 150 of the trigger 130 is inserted into the indentation 160 of the plunger 140, thereby securing the plunger 140 in a position, wherein the spring 170 is in a compressed state and the arm extensions 210a and 210b are in retracted position. The spring 170 in the compressed state stores a power for causing extension of the arm extensions 210 from the retracted position thereof.

The user may grip the gun member 100 using the gripping handle 120 to operate the trigger 130 for triggering the movement of the plunger 140 in the lateral direction for operating the pad members 200 to target and kill the insects. As shown in FIG. 2, when the trigger 130 is pressed, the notch 150 of the trigger 130 moves out from the indentation 160 of the plunger 140, thereby releasing the plunger 140. Accordingly, the power stored in the spring 170 moves the plunger 140 in a forward direction, thereby causing extension of the arm extensions 210 from the retracted position thereof. Extension of the retracted arm extensions 210 results in pressing of the first pad member 200a and the second pad member 200b against each other for closing the first pad member 200a and the second pad member 200b with a same power that is stored in the spring 170 in the compressed state thereof. Pressing of the first pad member 200a and the second pad member 200b against each other with the same power stored in the spring 170 results in trapping and killing of the insects therebetween.

Further, the user may reset the apparatus 1000 to the pre-strike position for subsequent trapping and killing of insects. In one embodiment of the present invention, the user applies a force for pushing the plunger 140 inwardly into the elongated barrel 110 for achieving the subsequent locking of the notch 150 and the indentation 160 for configuring the pre-strike position of the apparatus 1000. It will be evident to those skilled in the art that resetting the apparatus 1000 to its pre-strike position is described herein for exemplary purposes, and various such methods may be employed for resetting the apparatus 1000 by the user.

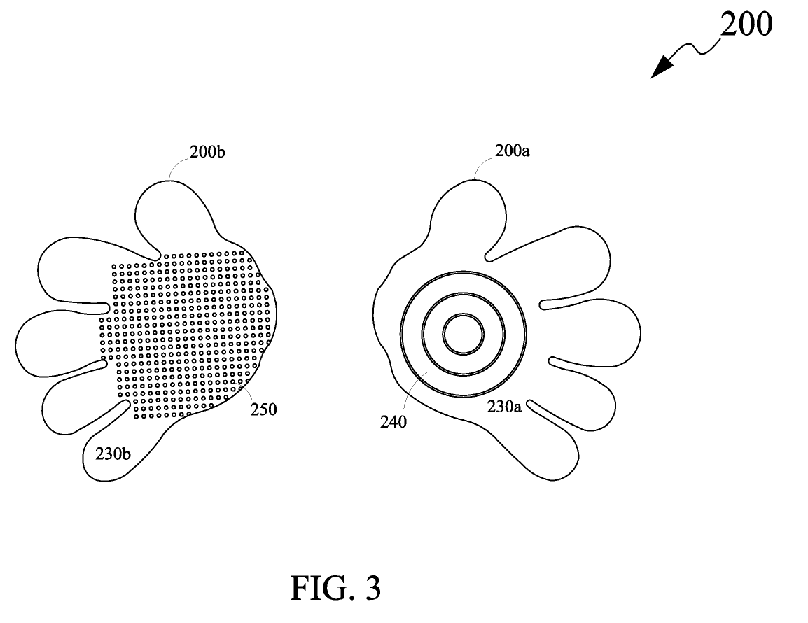

The power developed in the apparatus 1000 by the spring 170 is sufficient enough to press the first pad member 200a and the second pad member 200b with such a force that ensures killing of the insects trapped therebetween. The pad members 200 for effective trapping and killing of insects are discussed in conjunction with FIG. 3.

Referring now to FIG. 3, a perspective view of the pad members 200 is illustrated. As explained in conjunction with FIGS. 1 and 2, each of the pad members 200 is configured to define an outline of a human hand. The outline of the human hand may be dimensioned suitably to ensure suitable surface area for trapping and killing of insects. In an embodiment of the present invention, the outline of human hand is dimensioned to have a maximum span of about 5¾ inches. It will be evident to those skilled in the art that the each of the pad members 200 defining an outline of the human hand is depicted for exemplary purposes, and that the pad members 200 may be configured in a variety of shapes and sizes for ensuring effective trapping and killing of insects.

Each of the pad members 200 defines a flat surface, especially an inner surface (opposite to the outer surfaces of the each of the pad members 200 explained in conjunction with FIGS. 1 and 2) may be configured to be substantially flat. More particularly, the first pad member 200a includes a flat surface 230a, and the second pad member 200b includes a flat surface 230b. The flat surfaces 230a and 230b facilitate trapping and killing of the insects, therebetween on being pressed against each other with power developed in the spring 170, when the trigger 130 is pulled. In one embodiment of the present invention, at least one of the flat surfaces, such as the flat surface 230a or the flat surface 230b includes a flexible material disposed thereon. Further, in another embodiment of the present invention, at least one of the flat surfaces, such as the flat surface 230a or the flat surface 230b includes a tacky face configured thereon.

As shown in FIG. 3, the flat surface 230a includes a flexible material 240 disposed thereon, and the flat surface 230b includes a tacky face 250 configured thereon. However, it will be evident to a person skilled in the art to configure the first pad member 200a and the second pad member 200b, both having the flexible material 240 on the respective flat surfaces 230a and 230b thereof, or to configure the first pad member 200a and the second pad member 200b both having the tacky face 250 on the respective flat surfaces 230a and 230b thereof. Further, the flat surface 230a including the flexible material 240, and the flat surface 230b including the tacky face 250 is depicted for description purpose only, and, that the flat surfaces 230a and 230b may not be limited in scope to the configuration as described herein. Moreover, one or more modifications to the flat surfaces 230a and 230b may be contemplated for trapping and killing the insects.

In one embodiment of the present invention, the flexible material 240 is a sheet of plastic screen that is sufficiently flexible so as to readily deform against the insect or other target, and thereby sufficiently covering the insect or target so as to ensure killing thereof. In one embodiment of the present invention, the tacky face 250 is configured to secure a trapped insect on the flat surface 230b after the first pad member 200a and the second pad member 200b encloses the insect therebetween. The tacky face 250 facilitates collection and disposal of the trapped insect.

The apparatus 1000 as described in conjunction with FIGS. 1 to 3, may be suitably dimensioned to provide ease-of use to the user. In one embodiment of the present invention, the height of the gun member 100 is about 4½ inches. In another embodiment of the present invention, the total length of the apparatus 1000 is about 15 inches in order to facilitate the user to target insects at considerable distances, for trapping and killing thereto with the pad members 200. However, it will be evident to a person skilled in the art to configure the apparatus 1000 having the gun member 100 and the pad members 200 of any desired length and height for trapping and killing the insects therewith.

An insect control apparatus, such as the insect control apparatus 1000 of the present invention offers the following advantages. The insect control apparatus provides a dependable, accurate, and effective tool for the extermination of insects in indoor or outdoor environments. Further, the insect control apparatus precludes use of toxic chemicals and/or pesticides to exterminate the insects and otherwise provides a clean and safe means for the trapping and killing of the insects, without polluting the environment or posing threat to human health. Furthermore, the insect control apparatus may be retracted into a flat package and be readily stored and transported and readied for use.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. An insect control apparatus, comprising:
a gun member, the gun member comprising
an elongated barrel configured with a plunger mechanism, the plunger mechanism capable of a movement in a lateral direction,
a gripping handle adapted to extend from the elongated barrel at an angle to an axis of the elongated barrel, and
a trigger mechanism adapted to extend from the gripping handle, wherein the trigger mechanism is operably coupled to the plunger mechanism for triggering the movement of the plunger mechanism in the lateral direction; and
a pair of opposable pad members operably coupled to the gun member, wherein each opposable pad member of the pair of the opposable pad members comprises an arm extension disposed on the elongated barrel and capable of being actuated by the movement of the plunger mechanism in the lateral direction, and,
wherein actuating arm extensions of the pair of opposable pad members is capable of pressing the pair of opposable pad members against each other, and retracting the pair of opposable pad members from each other.

2. The insect control apparatus of claim 1, further comprising a resilient means configured within the elongated barrel for facilitating the lateral movement of the plunger mechanism.

3. The insect control apparatus of claim 2, wherein the resilient means is a spring.

4. The insect control apparatus of claim 1, wherein the each opposable pad member is configured to define an outline of a human hand.

5. The insect control apparatus of claim 1, wherein the each opposable pad member defines a flat surface.

6. The insect control apparatus of claim 5, wherein at least one flat surface corresponding to the opposable pad member of the pair of opposable pad members is composed of a flexible material.

7. The insect control apparatus of claim 5, wherein at least one flat surface corresponding to the opposable pad member of the pair of opposable pad members comprises a tacky face configured thereon.

8. The insect control apparatus of claim 1, wherein the arm extensions are configured to form a scissor arm configuration.
